(19) United States
(12) Patent Application Publication
(10) Pub. No.: US 2010/0179911 A1
(43) Pub. Date: Jul. 15, 2010

(54) COLLATERAL VALIDATION SYSTEM

(75) Inventors: Alla Gorina, San Diego, CA (US); Heidi L. Russell, Oceanside, CA (US); Ivan Raykov Ivanof, San Diego, CA (US); Vincent Stuart, Cardiff by the Sea, CA (US); Young M. Kim, Poway, CA (US)

Correspondence Address: RICHARD D. CLARKE;LAW OFFICE OF RICHARD D. CLARKE, 3755 AVOCADO BLVD., #1000, LA MESA, CA, 91941-7301, US

(73) Assignee: DATAQUICK INFORMATION SYSTEMS, INC., San Diego, CA (US)

(21) Appl. No.: 12/687,661

(22) Filed: Jan. 14, 2010

Related U.S. Application Data
(60) Provisional application No. 61/144,509, filed on Jan. 14, 2009.

(51) Int. Cl. G06Q 99/00; G06Q 10/00; G06Q 40/00; G06Q 50/00

(52) U.S. Cl. 705/306; 705/348

(57) ABSTRACT

The present invention is directed to a collateral validation system, and method providing an approach to automating valuation reconciliation. The collateral validation system is a fully automated validation of past and current valuations as well as allowing for forecasting future collateral values. It incorporates multiple independent opinions of value using a panel of experts approach employing multiple sub models along with housing price indices (HPIs), neighborhood level home price indices, premier data, external factors, analytics and predictive modeling, to enable a consensus approach, foreclosure trends, and external factors all user selectable and user weight adjustable for varying use configurations. As a result, a user may obtain a full and complete determination and validation of past and present value along with forecasted values coupled with statistical analyses in a fully customizable environment.

### FIELD OF THE INVENTION

The present invention is directed to a system for validating collateral, having as its primary uses portfolio acquisition, due diligence including secondary marketing and loan acquisition, loss mitigation decision support, and portfolio risk analysis.

### BACKGROUND OF THE INVENTION

Loan servicing companies need to periodically reconcile the values of the homes in their portfolios and report such information to investors. Then a loan is placed in default or the loan terms are modified, this is typically accomplished via a broker price opinion (“BPO”) as opposed to a full appraisal. A BPO is an estimate of the probable selling price of a residential property based on selling prices of comparable properties in the area or a drive-by inspection. The problem is that BPOs can be expensive, subject to individual bias, and may have a slow turn-around time. Additionally, there is a lack of “scalability,” or the ability to handle a very large workload in existing systems.

Collateral Validation is an innovative, transparent approach to automating valuation reconciliation. Understanding collateral value is the single most important problem today for Servicers, Lenders and Investors.

Unlike traditional AVM's where the approach is “winner takes all” and a one point in time estimate is provided, Collateral Validation incorporates multiple independent opinions of value using a “panel of experts approach” along with a Neighborhood Level Home Price Index, premier data, analytics and predictive modeling, unique “Consensus Approach”, foreclosure trends and more. In the end, there is a full and complete determination and validation of value along with forecasted values to help prioritize riskier loans more effectively.

Collateral Validation is a fully configurable and modular approach to validation that easily incorporates the best practices of a review staff and analysts so that reconciliation is automated and prioritized appropriately.

The integrated information and analysis that Collateral Validation provides is comprehensive, easy to interpret and detailed for all properties being analyzed and the subject of decision-making. Collateral Validation allows risk assessment and a clear supporting evidence of a validated value when negotiating loan acquisition and making decisions about disposition. Collateral Validation can also be configured for front-end origination processes and as an add-on to traditional valuation products.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

The principle advantage of this invention is to create a Collateral Validation System which is a fully configurable and modular approach to validation that easily incorporates the best practices of your review staff and analysts so that reconciliation is automated and prioritized appropriately.

Another advantage of this invention is to reconcile and analyze collateral value and risk in real time.

Another advantage of this invention is to create a proof of valuation conclusion with data-driven, objective housing price and default trends.

Another object of this invention is to create a scalable, automated collateral review workflow to improve efficiency.

Another object of this invention is to create an indication of how the value will be impacted in the near future.

Another object of this invention is to create a cost efficiency over traditional valuation reconciliation practices.

A final object of this invention is to create a new and unique, configurable system with no IT resources typically required.

The present invention is directed to an automated Collateral Validation system and method, an innovative, transparent approach to automating valuation reconciliation. Understanding collateral value is the single most important problem today for Servicers, Lenders and Investors. Collateral Validation is the solution that allows lower costs, reduced risks and better decision making. Collateral Validation offers the only fully automated “validation” of past or current valuations. Collateral Validation incorporates multiple independent opinions of value using a “panel of experts approach” along with Neighborhood Level Home Price Index, premier data, analytics and predictive modeling, unique “Consensus Approach”, foreclosure trends, and more. As a result, one obtains a full and comprehensive determination and validation of past values, present value, and future forecasted values to help prioritize riskier loans more effectively. Collateral Validation is a fully configurable and modular approach to validation that easily incorporates the best practices of a review staff and analysts so that reconciliation is automated and prioritized appropriately. The integrated information and analysis that Collateral Validation provides is comprehensive, easy to interpret and detailed for all properties being analyzed. Collateral Validation allows risk assessment and clear supporting evidence of a validated value when negotiating loan acquisition and making decisions about disposition. Collateral Validation can also be configured for front-end origination processes and as an add-on to traditional valuation products.

The present invention allows for user defined Meta Models, Experts and Sub Models as 1) Median, which takes the median value of the sub model estimates, 2) Weighted Average with user configurable prior weights, and allows the user to customize and weigh the importance of each sub model employed, and 3) Weighted Average with learned weights. User customized weights are learned based on past sub model performance. Consensus Value is the degree to which the experts agree. Expert Panels may also provide support for an individual estimate. A statistic that conveys how much the set of estimates support a single estimate (e.g., given a past appraised value, how much do the other estimates support this value) and casual factors for learned weights (e.g., weight is low for HPI if prior sale occurred more than five years ago).

It must be clearly understood at this time although the preferred embodiment of the invention consists of the collateral valuation means, that many conventional valuation methods exist, including inference engines and configurations, or combinations thereof, that will achieve the a similar operation and they will also be fully covered within the scope of this patent.

With respect to the above description then, it is to be realized that the optimum relationships for the parts of the invention, to include variations in size, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 depicts the Data Acquisition, Inference Engine, Report Generator and Configuration of the present Collateral Validation System;

FIG. 2A depicts a Suggested Grouping of sub-model experts used in Dataquick Sub-Model Estimates, Embedded Models and External Options using the present Collateral Validation System;

FIG. 2B depicts a Meta Model Consensus Value/Consensus Metric using varying Source, Subject Data and Expert databases for calculation of collateral validation using the present Collateral Validation System;

FIG. 3A depicts a Sub Model ‘Expert’ evolving into a graphical representation of an estimated market value and the meta model's single consensus value using the present Collateral Validation System;

FIG. 3B depicts a greater detail of the graphical representation of the Probability Density Function when calculating any given estimated market value using the present Collateral Validation System;

FIG. 4 depicts a Report Generator incorporating neighborhood trend, subject history and loan model using the present Collateral Validation System;

FIG. 5 depicts another Report Generator incorporating an Area Sales Activity Trend, NOD, NOT, REO Trend, Subject Property Details and Sales Price Histogram using the present Collateral Validation System;

FIG. 6 depicts Sales Comps. Configuration, History Configuration and History Report, and the flow of data using the present Collateral Validation System;

FIG. 7 depicts a Consensus Timeline illustrating the subject property value over time, with graphical representation of the Life of Loan Duration using the present Collateral Validation System;

FIG. 8 depicts a Consensus Timeline illustrating the subject property value over time, with graphical representation of the onset events (purchase, equity and refinance events) using the present Collateral Validation System;

FIG. 9 depicts a flow chart of Sub Model Results to Meta Model to Final Estimated value and Consensus Score, to Quick Sale Price Model and HPI Forecast leading to either Quick Sale Price or Forecast Value using the present Collateral Validation System; and

FIG. 10 illustrates the relationship of the factors entering into Meta Models, Consensus Value, Casual Factors for Learned Weights, Quick Sale Price and Forecasted Value using the present Collateral Validation System.

For a fuller understanding of the nature and objects of the invention, reference should be had to the following detailed description taken in conjunction with the accompanying drawings which are incorporated in and form a part of this specification, illustrate embodiments of the invention and together with the description, serve to explain the principles of this invention.

### DETAILED DESCRIPTION OF THE PREFERRED EMBODIMENTS

For a fuller understanding of the nature and objects of the invention, reference should be had to the following detailed description taken in conjunction with the accompanying drawings wherein similar parts of the invention are identified by like reference numerals.

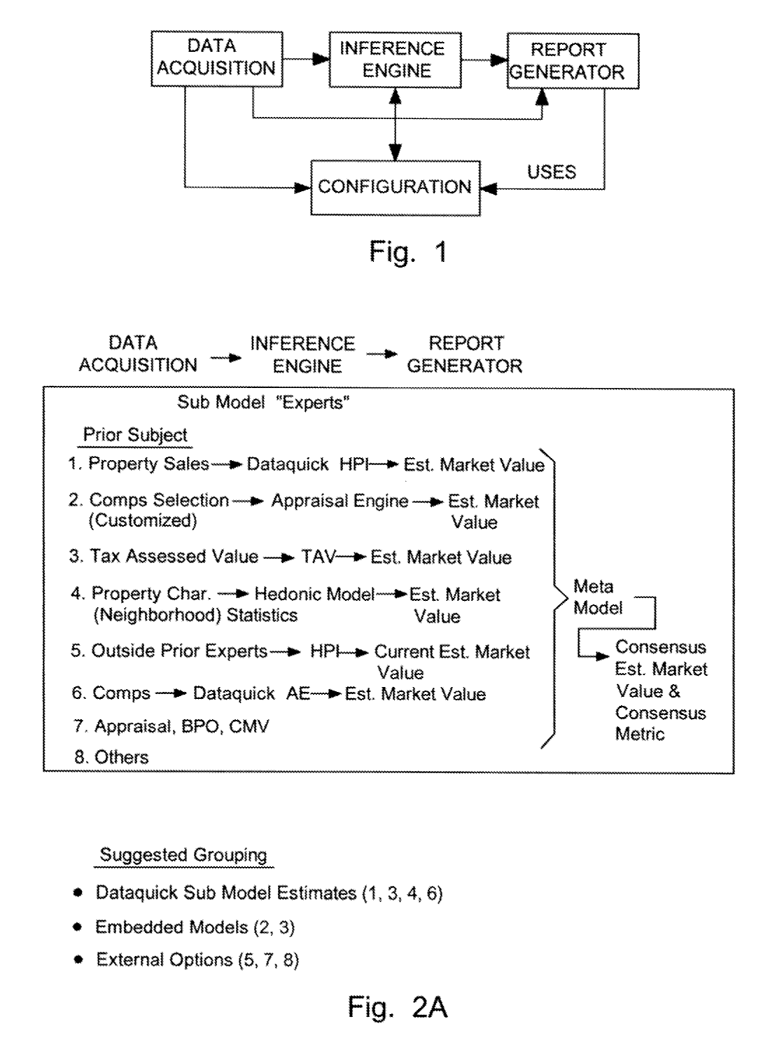

There is seen in FIG. 1 Top Level Flow of data and decision-making using the present Collateral Validation System. Data Acquisition from Data Sources which include Internal Expert Opinion Estimated Market Values table, External Inputs (External Experts), Transactional Data (Historical Transactions) and Property Characteristics (Assessor Data).

A collection of machine and human experts provide estimated market values (opinion) for the subject property. A meta model combines the individual expert opinions into a single estimated market value and a metric that measure the degree to which the experts are in consensus.

Batch Configuration are parameters to control batch processing. This configuration generates reports for all matches (Yes/No). Configuration parameters to control address matching, acceptable consensus metric threshold, minimum number of experts, flagging unusual subject property price change time window and price change threshold include Final Address Match Score Threshold, Coefficient of Dispersion Threshold (COD), Minimum Number of Experts, Price Change at 5 years, and Price Change Threshold.

Comparable Property Selection Configuration consists of configuration parameters to control the comparable selection process. These include number of cascades, highlight intersection, minimum comps, maximum comps which include REOs (1=Accept; 2=Exclude; 3=Use Filter).

Configuration parameters for step 1 of the comparable property selection process includes type of geographical search and parameters similarity of comparable property's property characteristics to subject property and transaction value filter. These include the following:
1. Step Name—SD, search type:
2. 1=Radius; 2=APN Page; 3=APN_Page; 3=APN_BOOK; 4=ZIP; 5=TRACT; 6=COUNTY, sales comps—Highlight Intersection, Sales Comps, Minimum Comps, Sales Comps Maximum Comps, Sales Comps—Include REOs (1=accept; 2=Exclude; 3=Use Filter),
3. Radius
4. Use Code Same as Target
5. Use Codes
6. City as Target
7. # of Bedrooms
8. # of bathrooms
9. SZFT
10. Lot Size
11. Sale Date (Recentcy of comp sale)
12. CV_Sale Amount
13. Number of Units From
14. Number of Units To
15. Year Built Advanced
16. Year Built
17. Pool Flag
18. Include Zero Amount Transactions
19. Suppress Non-Purchase Transactions
20. Owner Occupied Flag

Sales Comps—Step 2, are the same field as Step 1.

Sales Comps—Step 3, are the same fields as Step 1.

Sales Comps Step REO—Same as Step 1 except these are REO transactions

(Same fields as Step 1).

The Report Generator generates PDF File and Generates Flat File.

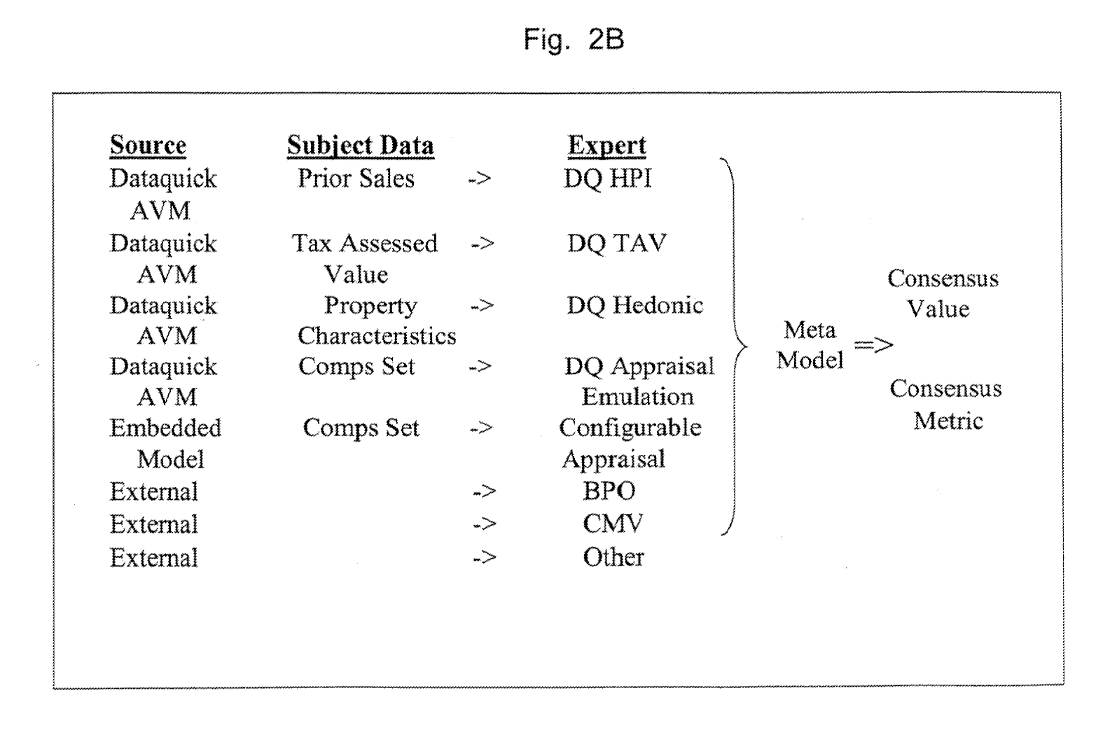

FIG. 2A exemplifies Models (Experts). Sub Models including House Price Index (HPI) Sub Model, an Appraisal Emulation (AE) Sub Model, a Taxed Assessed Value (TAV) Sub Model and Hedonic Sub Model. Embedded Models include Configurable Appraisal Model and House Price Index. External Expert Opinions Include Broker Price Opinion (BPO)—an appraiser's opinion of the current market value and Current Market Value (CMV)—A customer adjusted BPO value. An Original Appraisal is the appraised value at the time of origination. There may be other External Expert Opinions as well.

A Meta Model for Comps may consist of a Panel of Experts—All internal and external opinions are combined to form a panel opinion. A consensus Value is the consensus value is a value for the panel of experts. A Consensus Metric represents the degree that the individual panel of experts is in agreement.

FIG. 2B depicts an example of the types of sources, subject data and expert data that may be combined to generate the meta model and calculate the consensus value and consensus metric. DQ stands for Dataquick, and HPI is the house pricing index. Therefore, DQ HPI would represent the internal HPI as calculated by Dataquick and its proprietary systems. Other external sources are possible as well.

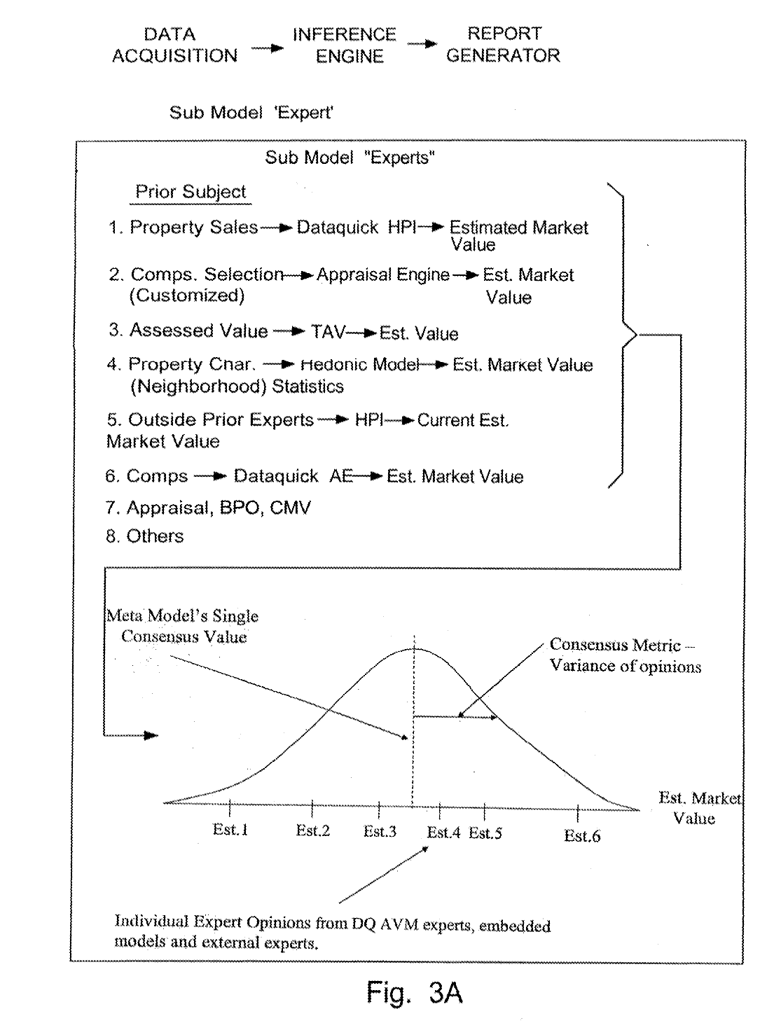

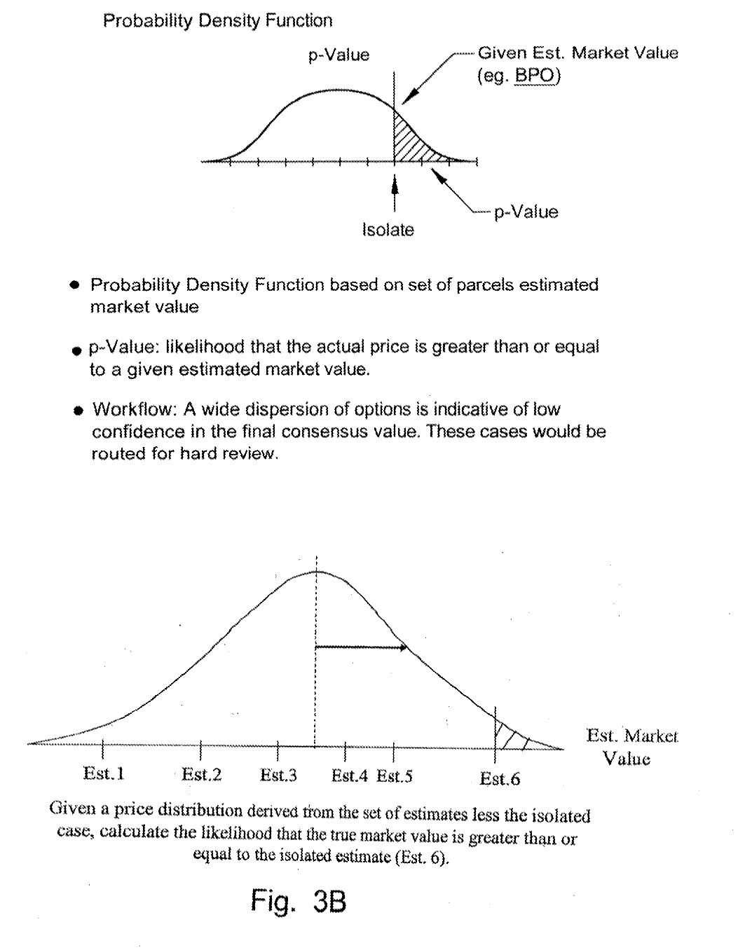

FIG. 3A depicts a Sub Model “Experts” flow chart including Prior Subject information. Property Sales, Comps Selection, Assessed Value, Property Characteristics, Outside Prior Experts, Comps (Estimated Market Value), Appraisal, BPO, CMV and “Others” are taken into consideration in arriving at an Estimated Market Value via an Inference Engine. This Prior Subject information includes (1) property sales subjected to HPI, in accordance with the current invention. The information from Sub Model “Experts” generates a Probability Density Function. This Probability Density Function Chart arrives at a Meta Model (Estimated Value Consensus Score) by graphing Agreement Consensus Scores by Parcel Estimated Market Value Comps. Selection data is processed by an appraisal engine (2). Property characteristics (neighborhood statistics) are processed by Hedonic Model, again arriving at an estimated market Value. Current Estimated Market Value is established by HPI. Comps from Outside Prior Experts, Comps, Appraisal, BPO, CMV and “Others” are combined to arrive at an estimated market value. Comps Selection are subjected to an Appraisal Engine arriving at an Estimated Market Value.

Turning now to FIG. 3B, there is a Probability Density Function based on a set of parcels estimated market value. Illustrated are Single cases versus Panel, the likelihood of an individual expert's opinion given the other panel members expert opinions. The p-Value is the likelihood that the actual price is greater than or equal to a given estimated market value. A workflow indicates a wide dispersion of options is indicated of low confidence in the final consensus value. These cases would be routed for hard review.

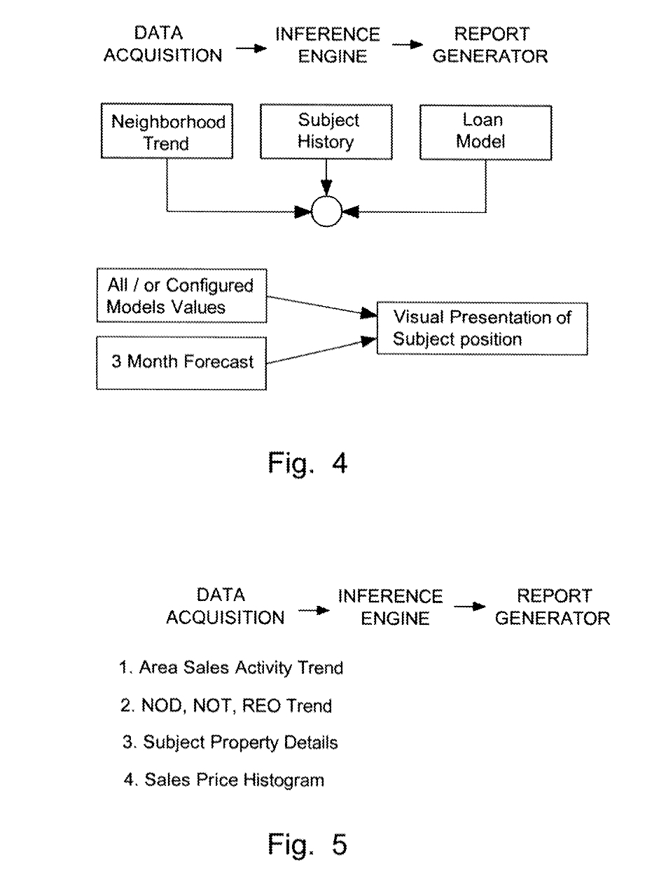

FIG. 4 is yet another representation of Report Generation utilizing Neighborhood Trend, Subject History and Loan Model data in order to generate a forecast as a visual presentation of subject position.

A summary of data which may be accumulated for use in prediction of sales price is exemplified by FIG. 5. A Sales Comps. Configuration is detailed in Area Sales Activity Trend, NOD, NOT, REO Trend, Subject Property Details and Sales Price Histogram, History Configuration also contribute to History Report. These are Data that may be predicted using the Data Acquisition processed by an Inference Engine.

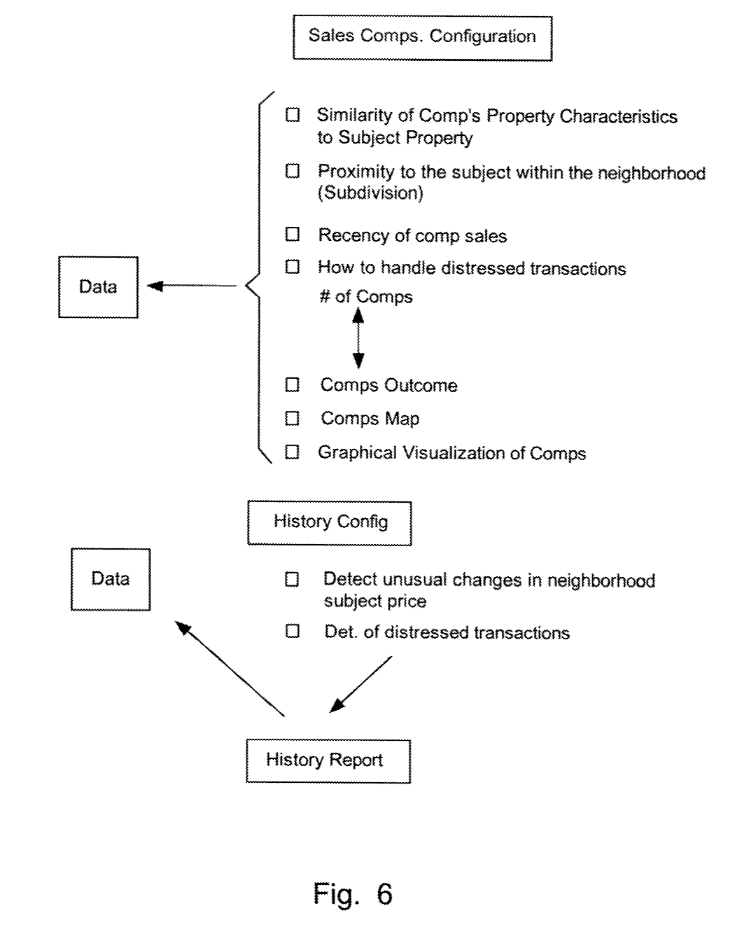

FIG. 6 is an Embedded Appraisal Model/Subject History which includes Sales Comps. Embedded Configurable Appraisal Model returns the median comps value as the expert opinion. Configurable filtering takes into consideration the type of comp sales transactions (e.g., REO), recentcy of comps sales, proximity of comps (e.g., within subdivision) to the subject property and similarity of the comp's hedonic features to the subject property.

These are taken into consideration when determining Comps Outcome, Comps Map and Graphical Visualization of Comps. Furthermore, a History Configuration consisting of detection of unusual changes in neighborhood subject price and Detection of distressed transactions are taken into consideration in a History Report.

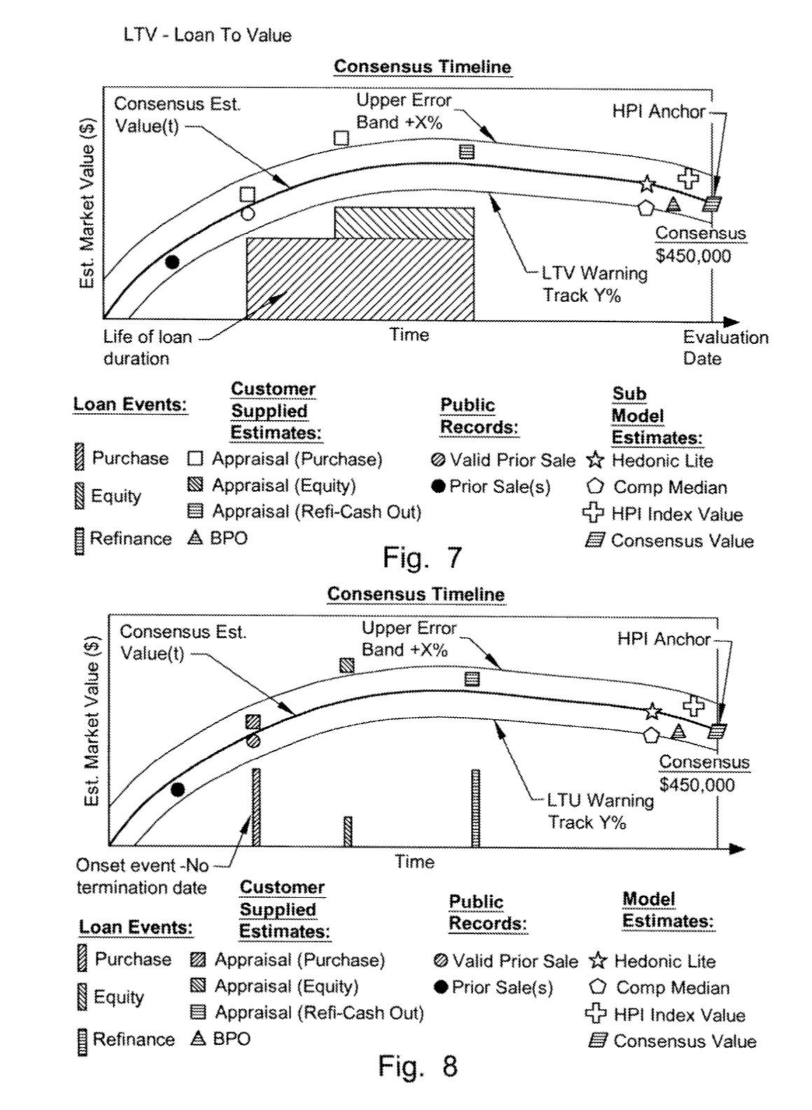

FIG. 7 depicts a Consensus Timeline. The X axis is time. The Y axis is the estimated market value in dollars. All expert opinions and prior sales events are plotted by when they happened and the estimated value. All expert opinions and prior sales events are plotted by when they happened and the estimated value. All loan events are plotted when they occurred, when they terminated, the type of loan and the loan position. The total loan amount is plotted by stacking active loans.

This Consensus Timeline indicates Consensus Estimated Value (t), Upper Error Band +X % which is a benchmark that shows any unusual opinion event being outside of a reasonable consensus value with the rest of the panel. Loan To Value, Warning Track Y %, HPI Anchor, Life of loan duration Consensus and Evaluation are included. Loan Events include Purchase, Equity, and Refinance. Customer Supplied Estimates include Appraisal (Purchase), Appraisal (Equity), Appraisal (Refi-Cash Out), and BPO. Public Records contain Valid Prior Sale and Prior Sale(s). Sub Model Estimates are Hedonic Lite, Comp Median, HPI Index Value and Consensus Value. The HPI curve shows the neighborhood trend line. The trend line is translated to dollars by typing it to the final consensus value.

Subject property history flags unusual changes in the subject properties sales prices and distressed transactions.

FIG. 8 depicts another Consensus Timeline with Life of Loan showing Onset event with no termination date. The information contained in this Consensus Timeline are Consensus Estimated Value(t), Upper Error Band +X %, LTV Warning Track Y %, HPI Anchor, Life of loan duration Consensus and Evaluation. Loan Events include Purchase Equity, Refinance. Customer Supplied Estimates include Appraisal (Purchase), Appraisal (Equity), Appraisal (Refi-Cash Out), and BPO. Public Records include Valid Prior Sale and Prior Sale(s). Model Estimates include Hedonic Lite, Comp Median, HPI Index Value and Consensus Value.

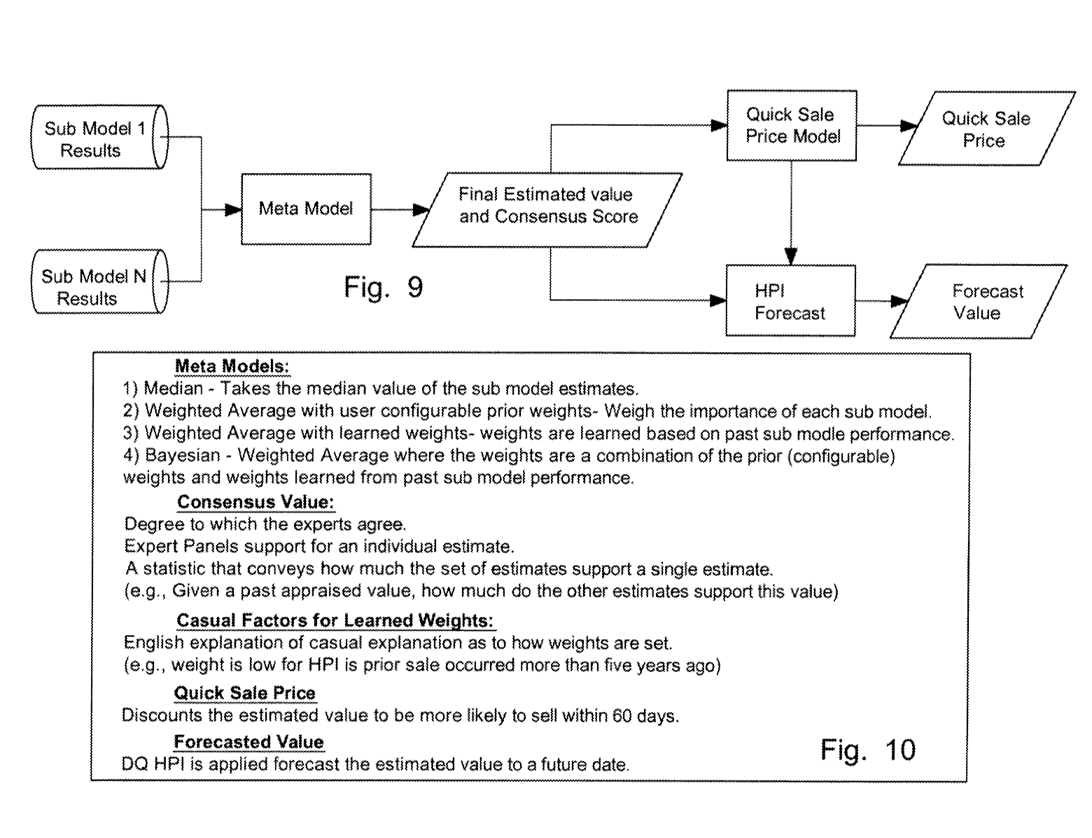

FIG. 9 illustrates a Model Assemblage. Sub Models with AVM sub model estimates are shown. External expert opinions (e.g., BPO, DMV, and Appraisals) are included.

The Meta Model combines individual opinions into a single consensus value and combine individual opinions into a consensus metric (degree of agreement of the panel of experts. Final consensus Value and Consensus Metric are determined.

A quick sale Price Adjustment is made. This is the discounted price set to sell the property in 60 days. The HPI Forecast establishes the estimated market value (consensus value) 90 days.

FIG. 10 defines Meta Models as 1) Median—takes the median value of the sub model estimates, 2) Weighted Average with user configurable prior weights—Weigh the Importance of each sub model, 3: Weighted Average with learned weights—weights are learned based on past sub model performance. Consensus Value is the Degree to which the experts agree. Expert Panels support for an individual estimate. A statistic that conveys how much the set of estimates support a single estimate (e.g., Given a past appraised value, how much do the other estimates support this value) Casual Factors for Learned Weights: in which an English explanation of casual explanation as to how weights are set (e.g., weight is low for HPI is prior sale occurred more than five years ago). Quick Sale Price Discounts the estimated value to be more likely to sell within 60 days. Forecasted Value is an HPI applied forecast of the estimated value to a future date.

Table 1 in Appendix I. (found on the pages following this specification and description) includes a typical Collateral Validation Report generated by the Collateral Validation System, in accordance with the present invention. Report output is fully customizable by the user for varying configuration uses, such as investing uses, lending uses, data gathering uses, etc. This example generated report includes the following fields of information:

(1) Property Reference Data including a Reference Number, and Property Address.

(2) Estimated Market Value includes Most Recent Purchase (showing Date and Price), Indexed Value showing Date, Value, Var. and Housing Price Index (HPI), Consensus Value including Date, Value and Metric. External Experts Opinion includes source, date and value.

(3) Market Area Trend includes graphical representation of Housing Price Index, Purchase, Refi/Eqt and Valuation Date illustrating Index per period. Area Sales Activity and Default Trend is a graphical representation of count per period of time. Number of units, NOT percentage and NOD percentage. A Report Summary indicates appreciation or depreciation for single family residences during a fixed period of time and includes stabilization during a given period of time as well as any projected change in the next several months. An unusually large change in pride is identified and in the subject's transaction history.

(4) Subject Property Market Area Comparison showing Subject Property Description in a Table format includes Subdivision, Sit and Mail Same, Use Code Tax assessed Year, Assessed Value, Assessed Market Value, Tax Amount, Year Build, Square Feet, Number of Bedrooms, Number of Bathrooms, Number of Stories, Pool and Effect Yr. Built. A graphical representation of Area Recent Sales Comparison shows Frequency versus Sales Price (in thousands)

(5) Sales Comps Detail includes Key, District, Owner Name, Site Address Sale Amount Sale Date, Document number, Year Built, Lot Size, Pool, Beds and Bathrooms, Square Feet, Price per Square Feet, APN, Assed Value, Use Code and Subdivision Tract.

(6) The Reference Map illustrates location of target properties and comps.

(7) Property History is a table containing transactions for the subject property. Transactions 1 through 6 include Buyer/Borrower, Seller Name, Lender Name, Transfer Date Transfer Value, Transaction Type, Document Number, Multiple/Portion, First Loan Amount, Second Loan Amount, Load Type, Interest Rate Type, and Deed Type. In the particular example report at hand, Transaction 1 listed HALL, JAMES D as the Buyer/Borrower. The Seller Name is CITATION NORTHERN. The Lender Name was COMMONWEALTH UNITED MTG CO. The date of transfer was Jun. 21, 1998. The Transfer Value was $226,500, the Transaction Type is a Subdivision. Document Number is 0000065240. Multiple Portion was Not Available. The First Loan Amount was $214,800. The Second Loan Amount was $0. The Loan Type was Conventional. The Interest Rate Type was Fixed and the Deed Type was Unknown.

(8) Sales Comps Detail is shown in graphical form. The Comparable Sales Information in tabular form indicates Low, Average and Maximum values for Sale Price, Square Feet, Number of Beds, Number of Baths, and the Year Built. Information shown in Graphical format includes Lot Size of comps and subject, Estimated Value vs. Comp Sales Price, Year Build of subject and comps, Square Footage of comps and subject property, Price per Square Feet for comps and subject estimate, Number of Bedrooms for comps and subject property, and Number of Bathrooms for comps and subject property.

The Collateral Validation System shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed for providing a Collateral Validation System in accordance with the spirit of the invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

We claim:

1. An automated collateral validation system for variably calculating past and present collateral values as well as forecasting future collateral values and statistically validating those collateral values comprising:
a) a data acquisition engine receiving data inputs from meta models and sub model experts;
b) an inference engine which enables the user to adjust which meta models and sub model experts data are employed and inputted, and allows the user to adjust varying weights assigned to each meta model and expert employed;
c) a report generator which enables the user to customize which fields of data are illustrated on the generated report, and which generates output as a user customized report on the consensus collateral value and its validation; and
d) one or more user customizable use configurations;
whereby when said data acquisition engine is programmed with sub-model experts as adjusted and weighted by the user, a consensus market value and consensus metric is calculated, and a report is generated illustrating user adjusted output results.

2. The automated collateral validation system for variably calculating past and present collateral values as well as forecasting future collateral values and statistically validating those collateral values, according to claim 1, wherein said data inputs from meta models and sub model experts includes sub model estimates from property sales, tax assessed values, property characteristics and comparables estimated market values.

3. The automated collateral validation system for variably calculating past and present collateral values as well as forecasting future collateral values and statistically validating those collateral values, according to claim 2, wherein said property characteristics are generated from neighborhood statistics through an hedonic model arriving at estimated market values.

4. The automated collateral validation system for variably calculating past and present collateral values as well as forecasting future collateral values and statistically validating those collateral values, according to claim 1, wherein said data inputs from meta models and sub model experts includes comparables selection through an appraisal engine arriving at estimated market values.

5. The automated collateral validation system for variably calculating past and present collateral values as well as forecasting future collateral values and statistically validating those collateral values, according to claim 1, wherein said data inputs from meta models and sub model experts includes outside prior expert data through housing price indices, appraisal data, BPO data and user provided external data to arrive at current estimated market values.

6. The automated collateral validation system for variably calculating past and present collateral values as well as forecasting future collateral values and statistically validating those collateral values, according to claim 1, wherein said one or more use configurations is custom programmed by the user to select sub models and assign varying weights to said selected sub models such that the automated collateral validation system is optimized for one or more differing programmed use configurations.

7. The automated collateral validation system for variably calculating past and present collateral values as well as forecasting future collateral values and statistically validating those collateral values, according to claim 1, wherein the consensus estimated value is calculated over a user chosen time period and is graphically displayed continuously throughout said user chosen time period.

8. The automated collateral validation system for variably calculating past and present collateral values as well as forecasting future collateral values and statistically validating those collateral values, according to claim 7, wherein the calculated consensus estimated value is displayed into the past, in the present, and into the future.

9. The automated collateral validation system for variably calculating past and present collateral values as well as forecasting future collateral values and statistically validating those collateral values, according to claim 1, wherein said report generator which enables the user to customize which fields of data are illustrated on the generated report, and which outputs a user customized report on the consensus collateral value, further includes data fields pertaining to property reference data, estimated market value, market area trend and subject property market area comparisons.

10. The automated collateral validation system for variably calculating past and present collateral values as well as forecasting future collateral values and statistically validating those collateral values, according to claim 9, wherein said generated report includes sales comparables details, a reference map, property history and sales comparables detail shown in graphical form.

11. An automated method for variably calculating past and present collateral values as well as forecasting future collateral values and statistically validating those collateral values, comprising the following steps:
a) providing a data acquisition engine receiving data inputs from meta models and sub model experts;
b) providing an inference engine which enables the user to adjust which meta models and sub model experts data are employed and inputted, and allows the user to adjust varying weights assigned to each meta model and expert employed;
c) providing a report generator which enables the user to customize which fields of data are illustrated on the generated report, and which generates output as a user customized report on the consensus collateral value and its validation; and
d) providing one or more use configurations;
whereby when said data acquisition engine is programmed with sub-model experts as adjusted and weighted by the user, a consensus market value and consensus metric is calculated, and a report is generated illustrating user adjusted results.

12. The automated method for variably calculating past and present collateral values as well as forecasting future collateral values and statistically validating those collateral values, according to claim 11, wherein said step of providing a data acquisition engine receiving data inputs from meta models and sub model experts further includes providing data inputs wherein said data inputs from meta models and sub model experts includes sub model estimates from property sales, tax assessed values, property characteristics and comparables estimated market values.

13. The automated method for variably calculating past and present collateral values as well as forecasting future collateral values and statistically validating those collateral values, according to claim 12, wherein said step of providing a data acquisition engine receiving data inputs from meta models and sub model experts further includes providing property characteristics wherein said property characteristics are generated from neighborhood statistics through an hedonic model arriving at estimated market values.

14. The automated method for variably calculating past and present collateral values as well as forecasting future collateral values and statistically validating those collateral values, according to claim 11, wherein said step of providing a data acquisition engine receiving data inputs from meta models and sub model experts further includes data inputs wherein said data inputs from meta models and sub model experts includes property comparables selection through an appraisal engine arriving at estimated market values.

15. The automated method for variably calculating past and present collateral values as well as forecasting future collateral values and statistically validating those collateral values, according to claim 11, wherein said step of providing a data acquisition engine receiving data inputs from meta models and sub model experts further includes data inputs wherein said data inputs from meta models and sub model experts includes outside prior expert data through housing price indices, appraisal data, BPO data and user provided external data to arrive at current estimated market values.

16. The automated method for variably calculating past and present collateral values as well as forecasting future collateral values and statistically validating those collateral values, according to claim 11, wherein said step of providing one or more use configurations wherein said one or more use configurations is custom programmed by the user to select sub models and assign varying weights to said selected sub models such that the automated collateral validation system is optimized for one or more differing programmed use configurations.

17. The automated method for variably calculating past and present collateral values as well as forecasting future collateral values and statistically validating those collateral values, according to claim 11, wherein said step of providing a report generator which enables the user to customize which fields of data are illustrated on the generated report, and which generates output as a user customized report on the consensus collateral value and its validation, wherein the consensus collateral value is calculated over a user chosen time period and is graphically displayed continuously throughout said user chosen time period.

18. The automated method for variably calculating past and present collateral values as well as forecasting future collateral values and statistically validating those collateral values, according to claim 17, wherein said step of providing a report generator which enables the user to customize which fields of data are illustrated on the generated report, and which generates output as a user customized report on the consensus collateral value and its validation, further includes generating a user customized report wherein the calculated consensus estimated value is displayed into the past, in the present, and into the future.

19. The automated method for variably calculating past and present collateral values as well as forecasting future collateral values and statistically validating those collateral values, according to claim 11, wherein said step of a report generator which enables the user to customize which fields of data are illustrated on the generated report, and which generates output as a user customized report on the consensus collateral value and its validation, further includes data fields pertaining to property reference data, estimated market value, market area trend and subject property market area comparisons.

20. The automated method for variably calculating past and present collateral values as well as forecasting future collateral values and statistically validating those collateral values, according to claim 19, wherein said step of a report generator which enables the user to customize which fields of data are illustrated on the generated report, and which generates output as a user customized report on the consensus collateral value and its validation, wherein said generated report includes sales comparables details, a reference map, property history and sales comparables detail shown in graphical form.
